(19) United States
(12) Patent Application Publication
(10) Pub. No.: US 2009/0152907 A1
(43) Pub. Date: Jun. 18, 2009

(54) Apparatus for exchanging driver's seat with passenger's seat

(75) Inventor: Jeong Hoon Lee, Gunpo (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/228,234

(22) Filed: Aug. 11, 2008

(30) Foreign Application Priority Data
Dec. 18, 2007 (KR) 10-2007-0133099

(51) Int. Cl. B60N 2/07

(52) U.S. Cl. 297/1

(57) ABSTRACT

An apparatus for exchanging a driver's seat with a passenger's seat of a vehicle comprises seat bases on which a driver's seat and a passenger's seat are provided, a main body assembly provided between the seats, and a link mechanism for linking the main body assembly to the respective seat bases. Seat motor(s) and a main motor of the main body assembly are controlled so as to directly exchange the seats.

### CROSS-REFERENCE TO RELATED APPLICATIONS

This application claims priority to Korean Application No. 10-2007-0133099, filed on Dec. 18, 2007, the entire disclosure of which is incorporated herein by reference.

### BACKGROUND

1. Technical Field

The present invention relates to an apparatus for exchanging a driver's seat with a passenger's seat of a vehicle.

2. Background Art

In order to relieve fatigue in long-distance driving, people usually take turns driving. However, it is inconvenient for a driver and a passenger to get out of the car and move to an another seat. It is very much inconvenient for a disabled driver or passenger. In order to overcome the inconveniences, apparatuses for exchanging a driver's seat with a passenger's seat have been proposed, for example, in Japanese Patent Laid-Open Publication Nos. 2000-062507, 2001-347859, and 2003-335158. However, these conventional apparatuses cannot directly exchange the seats.

The above information disclosed in this Background section is only for enhancement of understanding of the background of the invention and therefore it may contain information that does not form the prior art that is already known in this country to a person of ordinary skill in the art.

### SUMMARY OF DISCLOSURE

Accordingly, the present invention has been made keeping in mind the above problems occurring in the prior art, and an object of the present invention is to provide an apparatus that can directly exchange the position of a driver's seat with that of a passenger's seat.

In order to accomplish the above object, the present invention provides an apparatus for exchanging a driver's seat with a passenger's seat, the apparatus including: seat bases each provided on the driver's seat and the passenger's seat respectively, being movable on a portion of the floor of the vehicle and being rotatable by seat motors; a main body assembly provided between the driver's seat and the passenger's seat and having a main motor for rotation of the main body assembly; and link mechanisms each linking the respective seat bases to the main body assembly and having rotary points each provided at the center of the respective link mechanisms. The main body assembly is provided with rotating elements for rotating link arms of the link mechanisms so that included angles at the rotary points vary with rotation of the link arms.

The main body assembly, preferably, comprises: a cover; a base coupled to the cover to define a space therebetween; and a gear assembly comprising a driving gear coupled to a rotating shaft of the main motor and driven gears provided on both sides of the driving gear. The link arms are connected to the driven gears so as to be rotatable along with the driven gears.

The main body assembly may further comprise a clutch mechanism for moving up and down the driving gear so that the driving gear engages with or disengages from the driven gears, The driving gear is coupled or attached to the base of the main body assembly when the driving gear moves downwards.

The clutch mechanism, preferably, comprises a magnetic clutch secured to the cover with a coil wound in the magnetic clutch; and a slider provided between the magnetic clutch and the rotating shaft of the main motor and splined to the rotating shaft of the main motor in such a way as to move in a longitudinal direction of the rotating shaft of the main motor, a lower end of the slider being secured to the driving gear.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features of the invention are discussed infra.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual view showing an apparatus for exchanging a driver's seat with a passenger's seat according to an embodiment of the present invention;

FIG. 2 is a detailed view showing the apparatus of FIG. 1;

FIG. 3 is a partial cutaway view taken along line A-A of FIG. 2;

FIG. 4a is an enlarged sectional view of a main body assembly of FIG. 3;

FIG. 4b is a conceptual view showing a main motor of FIG. 3; and

FIGS. 5a to 10d are views showing a method of exchanging a driver's seat with a passenger's seat using the apparatus of FIG. 2, in which:

FIGS. 5a and 5b are views showing an apparatus according to an embodiment of the present invention before the start of exchanging seats,

FIGS. 6a to 6e are views showing the process of folding link mechanisms at 450 by rotating driven gears so as to reduce a rotating radius,

FIG. 7 is a view showing the operation of a clutch mechanism for rotating a main body assembly,

FIGS. 8a and 8b are views showing the state in which a main body assembly rotates clockwise and thus moves from the position of FIG. 6d or 6e by 45°.

FIGS. 9a to 9d are views showing the state in which the main body assembly rotates clockwise, and simultaneously seat motors rotate counterclockwise, so that the main body assembly moves from the position of FIG. 8a or 8b by 90°, and

FIGS. 10a to 10d are views showing the state in which the link mechanisms are unfolded from the state of FIG. 9c or 9d by rotating the driven gears.

### DETAILED DESCRIPTION

Hereinafter, an apparatus for exchanging a driver's seat with a passenger's seat according to a preferred embodiment of the present invention will be described with reference to the accompanying drawings.

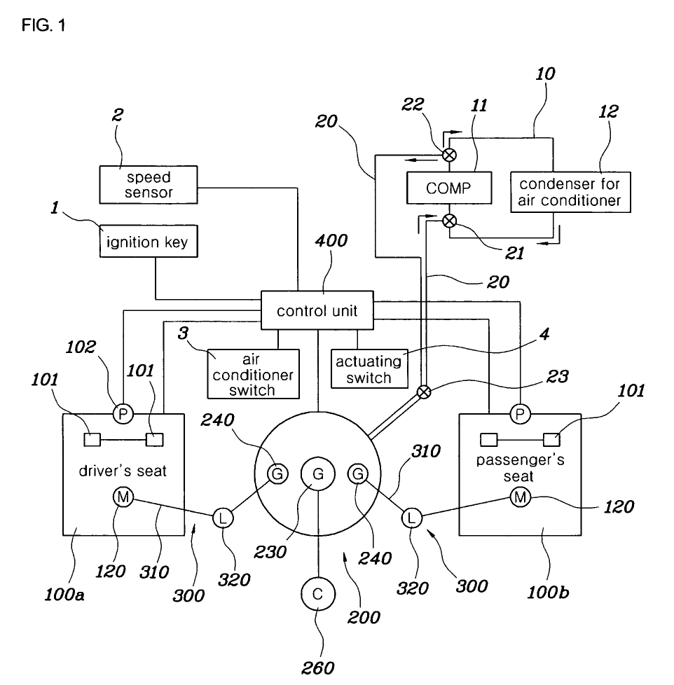

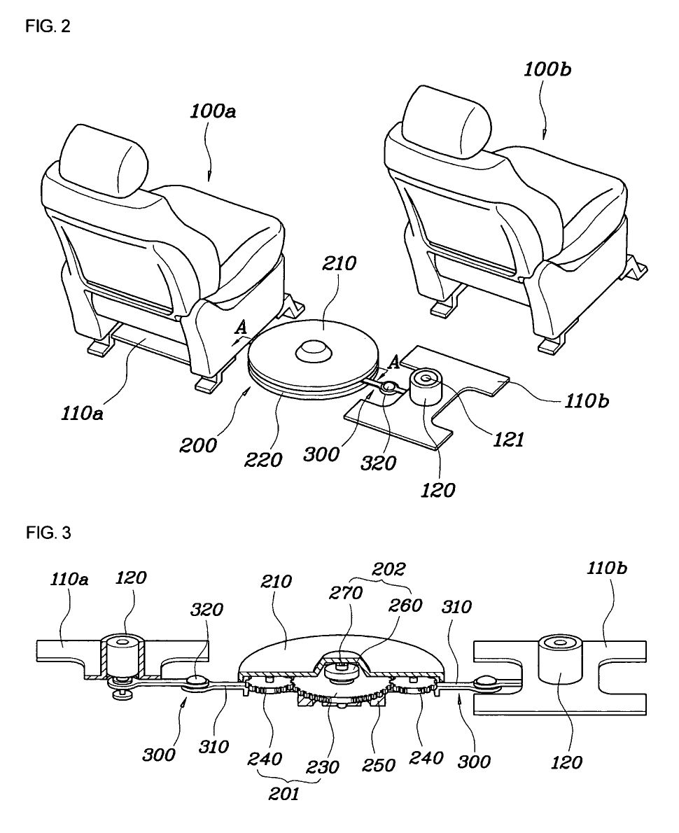

As shown in FIGS. 1 and 2, the seat exchanging apparatus includes seat bases 110a and 110b, a main body assembly 200, link mechanisms 300, and a control unit 400.

The seat bases 110a and 110b are provided on respective bottoms of a driver's seat 100a and a passenger's seat 100b, and are movable on a floor (not shown). A seat motor 120 is mounted to each of the seat bases 110a and 110b to rotate the respective seat bases 110a and 110b. Each of the driver's seat 100a and the passenger's seat 100b includes a locking part 101 and a position sensor 102. The locking part 101 locks each of the driver's seat 100a and the passenger's seat 100b to a predetermined position on the floor. The position sensor 102 detects the rotating angle of each of the driver's seat 100a and the passenger's seat 100b.

The main body assembly 200 is arranged on the floor between the driver's seat 100a and the passenger's seat 100b.

As shown in FIGS. 1 to 4b, the main body assembly 200 includes a cover 210, a base 220, a gear assembly 201, a main motor 250 and a clutch mechanism 202.

The cover 210 and the base 220 are coupled to each other to define a space therebetween.

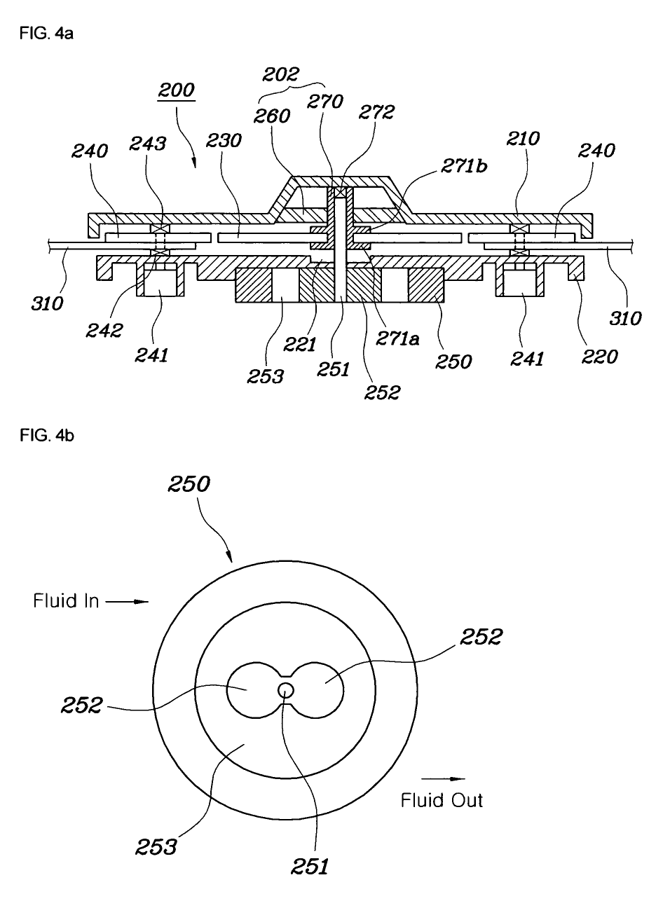

The gear assembly 201 comprises a driving gear 230 and driven gears 240 provided on both sides of the driving gear 230 respectively. A rotating shaft 251 of the main motor 250 passes through the base 220 and is coupled to the driving gear 230. The upper end of the rotating shaft 251 is connected to the cover 210 (see FIG. 4a).

The driving gear 230 is configured to be able to rotate with the rotating shaft 251 of the main motor 250. As the driving gear 230 rotates, the driven gears 240 are operated in conjunction with the driving gear 230 and are rotated in the opposite direction as the driving gear 230. When the driving gear 230 is engaged with the driven gears 240, the driving gear 230 is spaced apart from the base 220 by a predetermined interval. If no force acts on the driving gear 230, the driving gear 230 drops due to gravity and is thus seated on the base 220.

An actuator 241 is provided on the bottom of the base 220 to be positioned under each of the driven gears 240 and holds the respective driven gears 240 at a predetermined position. The actuator 241 may comprise an electric motor.

The main motor 250 rotates the main body assembly 200. In particular, the main motor 250 is constructed so that, when pressurized fluid flows into the interior 253 thereof, a vane 252 rotates about the rotating shaft 251 of the main motor 250 due to hydraulic pressure. The rotating direction of the vane 252 is changed according to the direction in which fluid flows. Suitably, a refrigerant for air conditioner, which circulates between a compressor 11 and a condenser 12, may be used as the fluid for rotating the vane 252. Also suitably, a pressure pump coolant may be used as the fluid for rotating the vane 252. In case of the refrigerant being used as the fluid for rotating the vane 252, the refrigerant is, as shown in FIG. 1, fed through fluid lines 20, which branch from a refrigerant line 10 for the air conditioner. A reverse valve 23 is provided on the fluid lines 20 and converts the direction of the refrigerant fed to the vane 252. Two bypass valves 21 and 22 are installed on the refrigerant line 10 in such a way as to be positioned at inlet and outlet sides of the compressor 11. Examples of the main motor 250 includes an electric motor.

The clutch mechanism 202 functions to move the driving gear 230 up and down so that the driving gear 230 may engage with or disengages from the driven gears 240. When the driving gear 230 moves downwards, the driving gear 230 is coupled or attached to the base 220.

The clutch mechanism 202 comprises a magnetic clutch 260 and a slider 270.

The magnetic clutch 260 is a hollow metallic part which is installed at the center of the cover 210. The rotating shaft 251 of the main motor 250 extends through the hollow metallic part and a coil (not shown) is wound in the inner circumference of the hollow metallic part.

The slider 270 is provided between the magnetic clutch 260 and the rotating shaft 251 of the main motor 250. The slider 270 is a hollow element which is splined to the rotating shaft 251 of the main motor 250 in such a way as to move along the rotating shaft 251 of the main motor 250. The lower end 271a of the slider 270 is secured to the driving gear 230 and a bearing 272 is provided on the upper end of the slider 270. When power is supplied to the coil, the slider 270 is forced to move upwards or downwards along the rotating shaft 251. The direction of movement of the slider 270 is controlled by the current direction supplied to the coil. When the magnetic clutch 260 moves the slider 270 downwards, the driving gear 230 is in close contact with or attached to the base 220. Thus, when the driving gear 230 is rotated, the base 220 is also rotated (if the base rotates, the cover also rotates). When the driving gear 230 comes into close contact with the base 220, the lower end 271a of the slider 270 is seated in a seating depression 221 provided in the base 220.

Meanwhile, as shown in FIG. 4a, the upward moving distance of the slider 270 is limited by the length of the slider 270. In order to limit the upward moving distance of the slider 270, the driving gear 230 and the driven gears 240 may comprise bevel gears. In this case, the driving gear 230 may be tapered upwards, and each driven gear 240 may be tapered downwards.

As shown in FIGS. 1 to 4a, the respective link mechanisms 300 link the main body assembly 200 to the seat bases 110a and 110b, with a rotary point 320 provided on the center of the link mechanism 300. Each of the link mechanisms 300 includes a link arm 310. The link arm 310 is secured to the corresponding driven gear 240. When the driven gear 240 rotates, the corresponding link arm 310 is also rotated, so that the included angle at the rotary point 320 becomes changed. Reference numeral 242 denotes a bearing.

The control unit 400 controls the operation of the seat motors 120 and the main motor 250, and, in addition, controls the actuators 241 of the driven gears 240, the magnetic clutch 260, and the valves 21, 22, and 23. The seat exchanging apparatus is operated when an ignition key 1 is engaged, a speed sensor 2 indicates “0”, and an actuating switch 4 is on. When the actuating switch 4 is turned on, the compressor 11 is driven, but the two bypass valves 21 and 22 supply the refrigerant to the fluid lines 20, so that an air-conditioning operation is not actually performed.

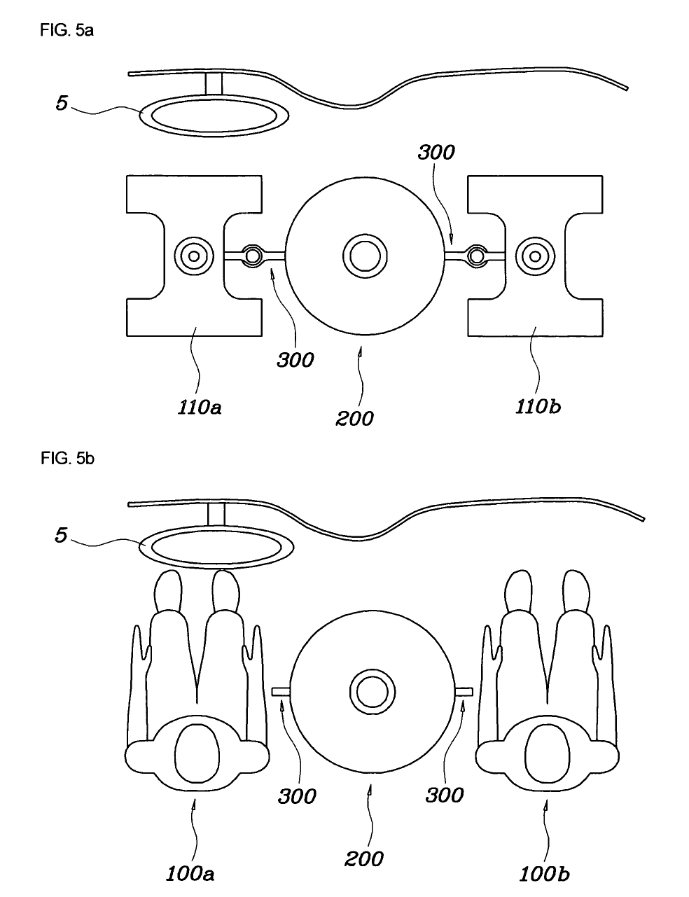

A method of changing the positions of the seats using the seat exchanging apparatus will be described with reference to FIGS. 5a to 10d.

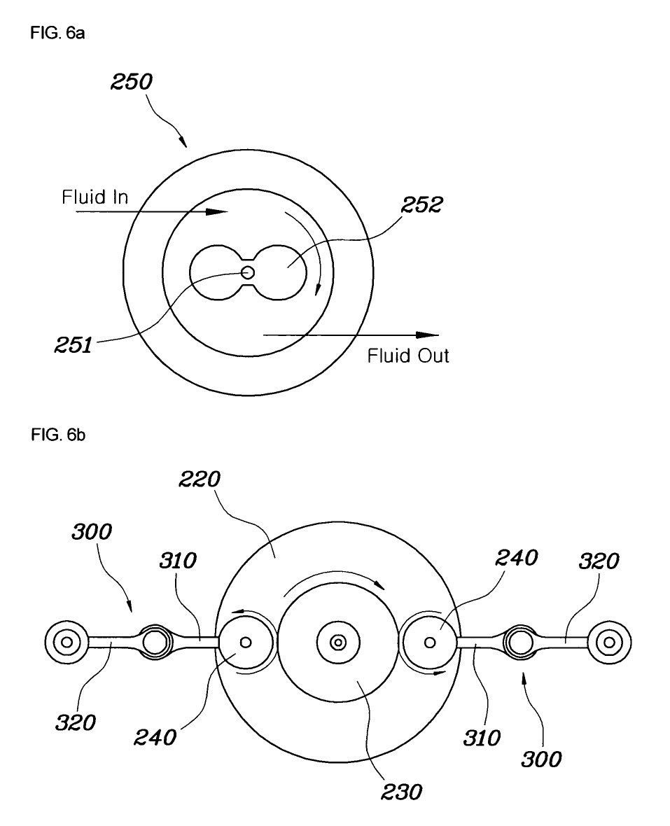

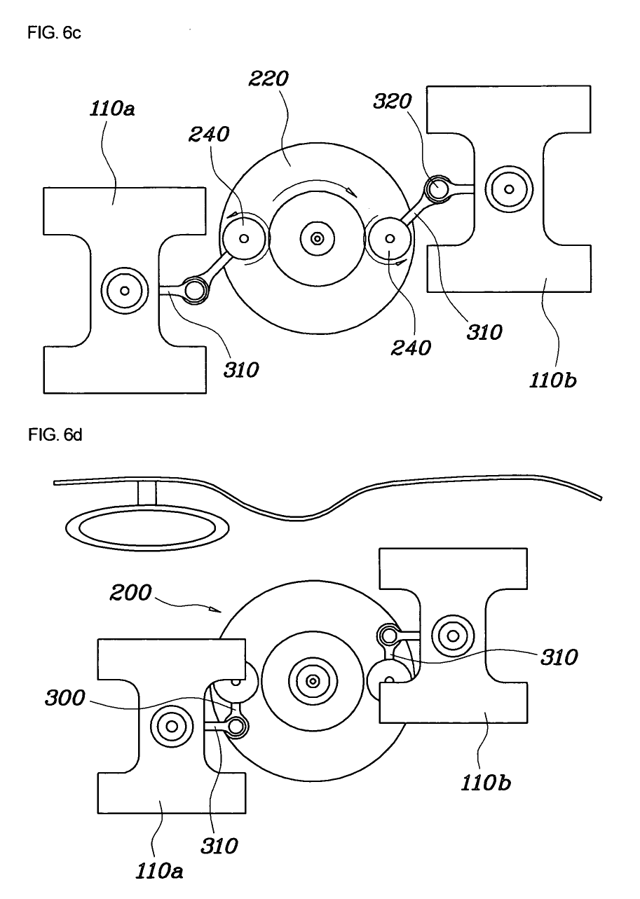

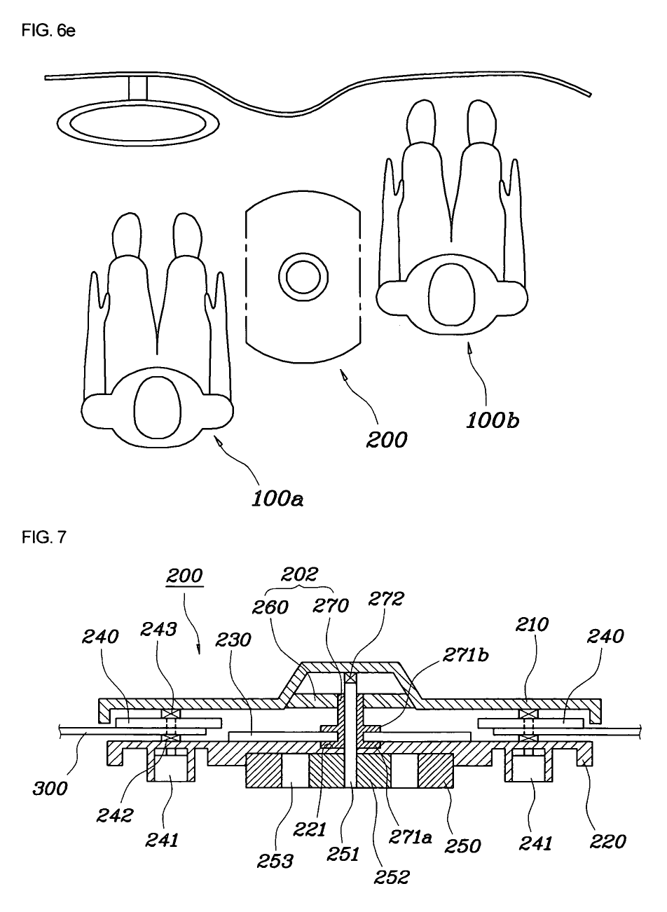

FIGS. 5a and 5b show an initial arrangement of the driver's seat and the passenger's seat. When the actuating switch 4 is turned on, the control unit 400 controls the compressor 11 and the bypass valves 21 and 22, so that the refrigerant for the air conditioner is fed into the main motor 250. Thereby, the vane 252 rotates clockwise around the rotating shaft 251 (see FIG. 6a). At this time, the magnetic clutch 260 pulls the slider 270 so that the driving gear 230 engages with the driven gears 240. When the vane 252 rotates clockwise, the driving gear 230 also rotates clockwise, and the driven gears.240 rotate counterclockwise (see FIG. 6b). The link arm 310 of each link mechanism 300, coupled to the corresponding driven gear 240, is rotated by the driven gear 240. Thus, each link mechanism 300 is bent at the rotary point 320, and the seat bases 110a and 110b rotate counterclockwise. The coupling force of each rotary point 320 is adjusted such that the included angle at the rotary point 320 and the rotating extent of the respective seat bases 110a and 110b are present within predetermined ranges. By the rotation of each driven gear 240, the corresponding link mechanism 300 is finally bent at 90°, and thus, the respective seat bases 110a and 110b are positioned in diagonal direction with each other (see FIGS. 6d and 6e). Therefore, the rotating radius of the seat bases 110a and 110b is reduced to the minimum.

In the state of FIG. 6d or 6e, the control unit 400 controls the magnetic clutch 260 so that the driving gear 230 disengages from each driven gear 240, and thus is in close contact with or attached to the base 220. The actuator 241 of each driven gear 240 is controlled so that the driven gear 240 does not rotate any further and is fixed to a predetermined position. In this state, the driving gear 230 is rotated by the rotating shaft 251 of the main motor 250, so that the entire main body assembly 200 is rotated.

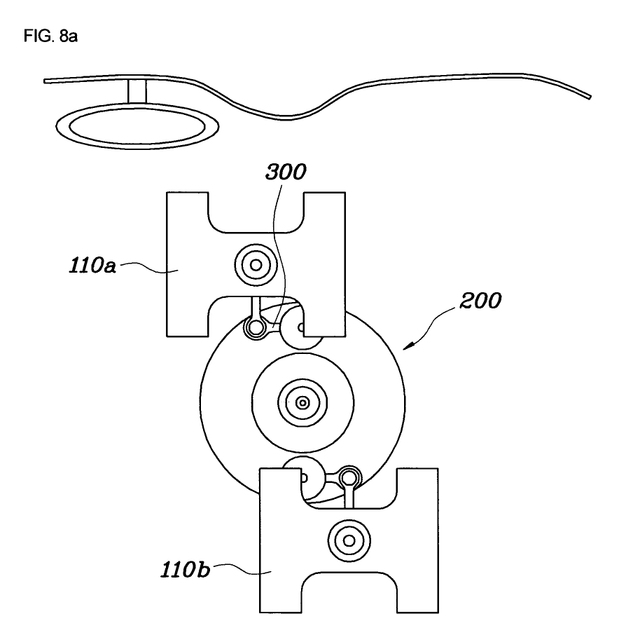

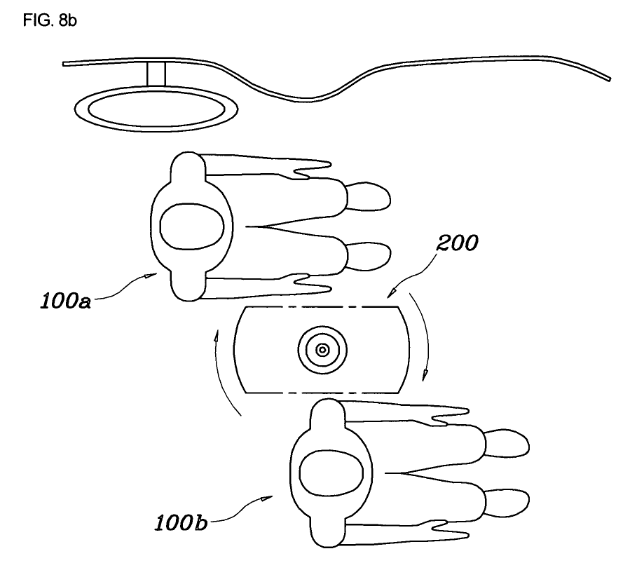

After the process of FIG. 7 is completed, the control unit 400 rotates the rotating shaft 251 of the main motor 250 so that the seat bases 110a and 110b are rotated clockwise at 90° (see FIGS. 8a and 8b).

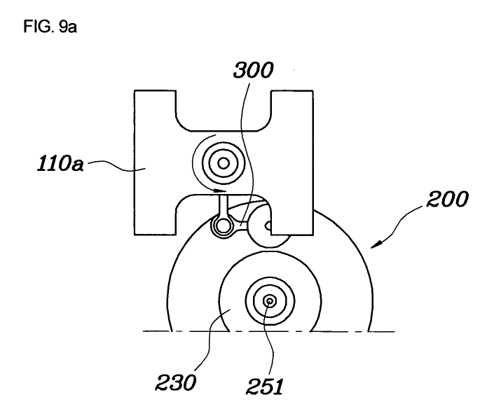

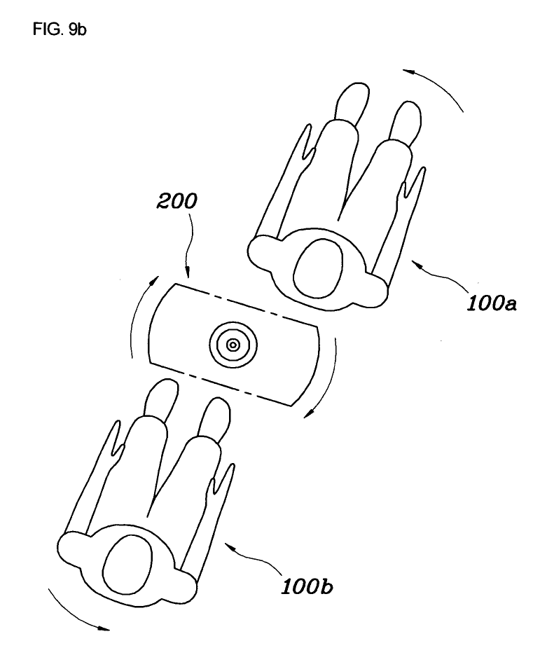

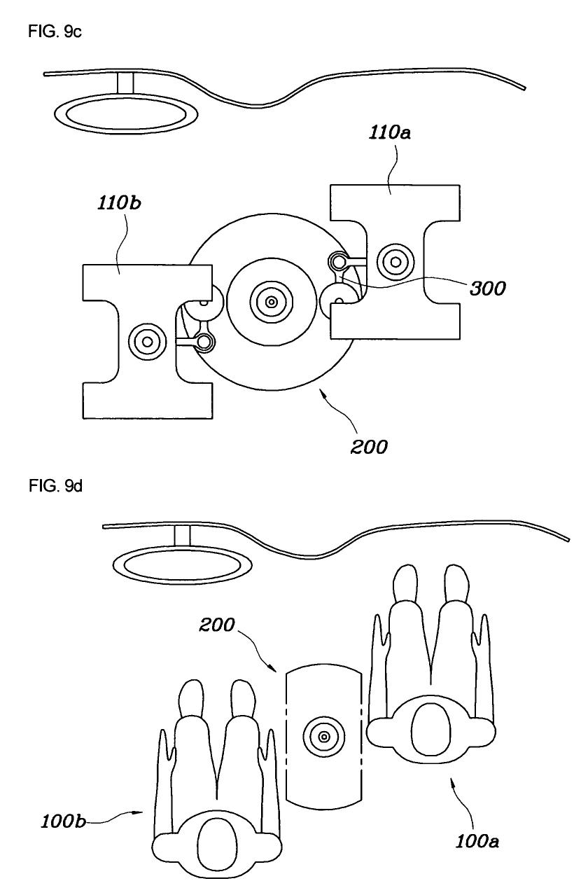

After the process of FIGS. 8a and 8b is completed, the control unit 400 further rotates the main body assembly 200 clockwise at 90°, and simultaneously drives the seat motors 120 so that the seat bases 110a and 110b rotate counterclockwise at 90° (see FIGS. 9a to 9d). This process allows persons sitting in the driver's seat and the passenger's seat to face the front of the vehicle, and minimizes the rotating radiuses of the driver's seat 100a and the passenger's seat 100b.

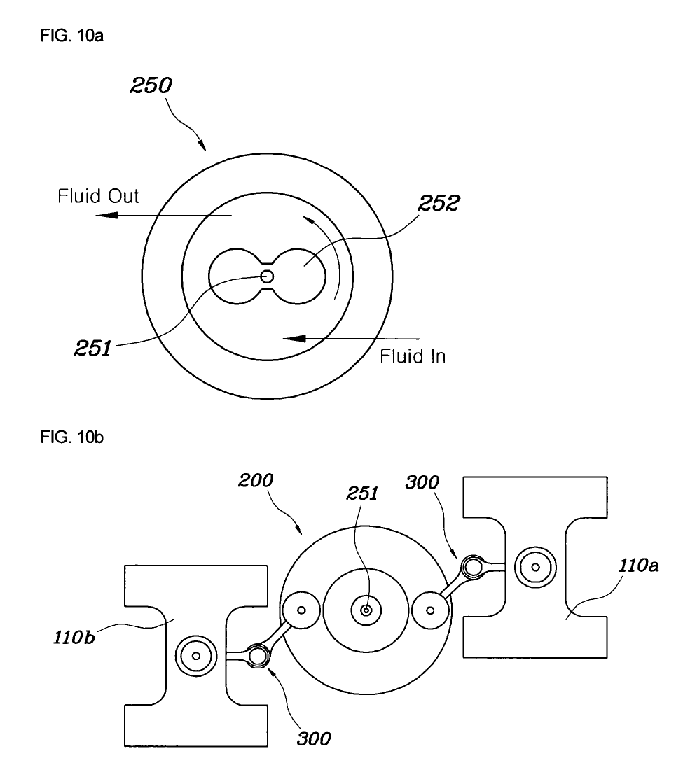

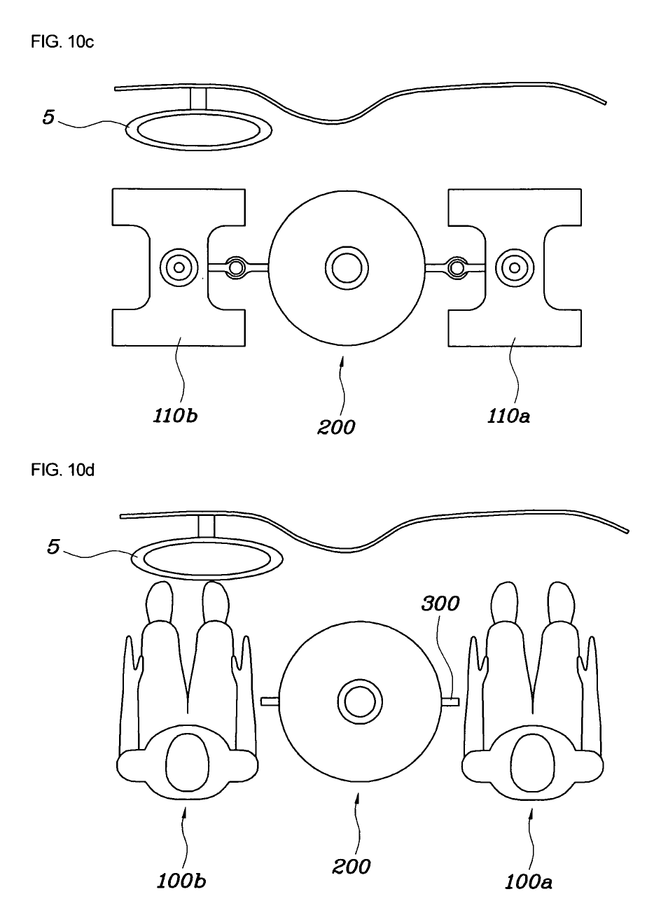

In FIG. 9c or 9d, the main body assembly 200 is rotated at 180°, but each link mechanism 300 is still bent at 90°. Therefore, the control unit 400 unfolds the link mechanisms 300 to completely exchange the driver's seat with the passenger's seat. That is, the control unit 400 controls the reverse valve 23 so as to change the directions in which the refrigerant flows in and out of the main motor 250. Further, the control unit 400 controls the magnetic clutch 260 so that the driving gear 230 engages with the driven gears 240, and thereafter, rotates the rotating shaft 251 of the main motor 250 counterclockwise, rotates the driving gear counterclockwise, and rotates the driven gears clockwise, so that the link mechanisms 300 move downwards. Consequently, the bent link mechanisms 300 are unfolded (see FIGS. 10a to 10d).

As described above, the present invention provides an apparatus capable of directly exchanging a driver's seat with a passenger's seat, which enables seats to rotate with a small rotational radius so that it is not necessary to change existing layouts of vehicles.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for exchanging a driver's seat with a passenger's seat of a vehicle, comprising:
seat bases each provided on the driver's seat and the passenger's seat respectively, being movable on a portion of the floor of the vehicle and being rotatable by seat motors;
a main body assembly provided between the driver's seat and the passenger's seat and having a main motor for rotation of the main body assembly; and
link mechanisms each linking the respective seat bases to the main body assembly and having rotary points each provided at the center of the respective link mechanisms; wherein,
the main body assembly is provided with rotating elements for rotating link arms of the link mechanisms so that included angles at the rotary points vary with rotation of the link arms.

2. The apparatus according to claim 1, wherein the main motor is constructed so that a vane is rotated about a rotating shaft of the main motor by hydraulic pressure of fluid.

3. The apparatus according to claim 2, wherein the fluid is supplied through a fluid line, which branches from a refrigerant line at each of inlet and outlet sides of a compressor for an air conditioner, and a reverse valve is provided on the fluid line to convert a direction of the refrigerant fed to the vane.

4. The apparatus according to claim 1, wherein the main body assembly comprises:
a cover;
a base coupled to the cover to define a space therebetween; and
a gear assembly comprising a driving gear coupled to a rotating shaft of the main motor and driven gears provided on both sides of the driving gear, wherein
the link arms of the link mechanisms are connected to the driven gears so as to be rotatable along with the driven gears.

5. The apparatus according to claim 4, wherein the main body assembly further comprises:
a clutch mechanism for moving up and down the driving gear so that the driving gear engages with or disengages from the driven gears, wherein
the driving gear is coupled or attached to the base of the main body assembly when the driving gear moves downwards.

6. The apparatus according to claim 5, wherein an actuator is provided at a predetermined position on each of the driven gears so as to hold the respective driven gears at a predetermined position.

7. The apparatus according to claim 5, wherein the clutch mechanism comprises:
a magnetic clutch secured to the cover with a coil wound in the magnetic clutch; and
a slider provided between the magnetic clutch and the rotating shaft of the main motor and splined to the rotating shaft of the main motor in such a way as to move in a longitudinal direction of the rotating shaft of the main motor, a lower end of the slider being secured to the driving gear.

8. The apparatus according to claim 7, wherein an upward moving distance of the slider is limited by the length of the slider.

9. The apparatus according to claim 7, wherein the driving gear and the driven gears comprise bevel gears, the driving gear being tapered upwards and the driven gears being tapered downwards.

10. The apparatus according to claim 1, wherein each of the driver's seat and the passenger's seat is provided with a locking part for locking the driver's seat and the passenger's seat to a predetermined position on the floor respectively.

11. The apparatus according to claim 1, wherein each of the driver's seat and the passenger's seat is provided with a position sensor for detecting a rotating angle of the driver's seat and the passenger's seat respectively.
